(19) United States
(12) Patent Application Publication
(10) Pub. No.: US 2025/0294242 A1
(43) Pub. Date: Sep. 18, 2025

(54) ELECTRONIC CONTROL UNIT

(71) Applicant: DENSO CORPORATION, Kariya-city (JP)

(72) Inventors: KENTO TABATA, Kariya-city (JP); MASAO KIMURA, Kariya-city (JP)

(21) Appl. No.: 19/058,106

(22) Filed: Feb. 20, 2025

(30) Foreign Application Priority Data
Mar. 14, 2024 (JP) 2024-040161

(51) Int. Cl. H04N 23/65; H02H 1/00; H02H 3/087

(52) U.S. Cl. CPC H04N 23/65; H02H 1/0007; H02H 3/087

(57) ABSTRACT

An electronic control unit supplies power to a camera via a communication line. The electronic control unit includes a camera power supply, a discharge unit, an enable control unit, an overcurrent detection unit and an abnormality detection unit. The camera power supply generates the power that is supplied to the camera. The discharge unit discharges the power generated by the camera power supply. The enable control unit switches an operation of the camera power supply and the discharge unit between an enabled state and a disabled state. The overcurrent detection unit detects whether or not an overcurrent exists in the camera power supply, on a condition that the enable control unit switches the operation of the discharge unit to the enabled state at startup of the camera power supply. The abnormality detection unit detects an abnormality of the camera power supply, based on a result of the overcurrent detection.

### CROSS REFERENCE TO RELATED APPLICATION

This application is based on Japanese Patent Application No. 2024-040161 filed on Mar. 14, 2024, the disclosure of which is incorporated herein by reference.

### TECHNICAL FIELD

The present disclosure relates to an electronic control unit.

### BACKGROUND

When connecting a camera and an electronic control unit (ECU) within a vehicle via a communication line, a Power Over Coax (PoC) configuration, which superimposes power onto the communication line, has become mainstream. According to this PoC configuration, power can be supplied to the camera using the communication line.

### SUMMARY

The present disclosure describes an electronic control unit including a camera power supply, a discharge unit, an enable control unit, an overcurrent detection unit, and an abnormality detection unit.

### BRIEF DESCRIPTION OF DRAWINGS

FIG. 1 is a block diagram schematically showing a configuration of an ECU in a first embodiment.

FIG. 2 is an electrical configuration diagram of a discharge unit in the first embodiment.

FIG. 3 is a time chart according to the first embodiment.

FIG. 4 illustrates a comparative example.

FIG. 5 is a flowchart schematically showing an abnormality detection process according to a second embodiment.

FIG. 6 is a block diagram schematically showing a system configuration according to a third embodiment.

FIG. 7 is a time chart according to the third embodiment.

FIG. 8 is a flowchart schematically showing an abnormality detection process according to a fourth embodiment.

### DETAILED DESCRIPTION

In the future, it may be necessary to equip a vehicle with many cameras to capture the surroundings and the interior conditions. With the increase in the number of cameras installed, it is anticipated that a switch circuit for switching the power supply from the camera power supply unit to each camera will be provided.

In the event of a power supply abnormality in multiple cameras, the switch circuit may be used to individually stop the power supply to the affected cameras, thereby allowing the cameras that are capable of normal operation to continue their imaging functions. However, depending on the number of cameras connected, it may be necessary to add switch circuits and discharge circuits for the internal charge of the cameras, which poses challenges in terms of increased cost and size.

Furthermore, to address the above-mentioned issues, if the switch circuits are removed, it may be necessary to set the overcurrent detection threshold according to the total current of all cameras in operation when multiple cameras are connected. When a single camera experiences a short circuit fault, depending on the characteristics of the components used, there is a possibility that the overcurrent detection threshold may not be exceeded, making it impossible to detect the power abnormality. Here, although challenges have been illustrated in the case of connecting multiple cameras, even when a single camera is connected, depending on the characteristics of the components used, the overcurrent detection threshold may not function properly, making it difficult to detect power supply abnormality.

According to a first aspect of the present disclosure, an electronic control unit supplies power to a camera via a communication line having a Power over Coax system. The electronic control unit includes a camera power supply, a discharge unit, an enable control unit, an overcurrent detection unit and an abnormality detection unit. The camera power supply generates the power supplied to the camera. The discharge unit discharges the power generated by the camera power supply. The enable control unit switches an operation of the camera power supply and an operation of the discharge unit between an enabled state and a disabled state. The overcurrent detection unit executes overcurrent detection to detect whether an overcurrent exists in the camera power supply, on a condition that the enable control unit switches the operation of the discharge unit to the enabled state at startup of the camera power supply. The abnormality detection unit detects whether an abnormality of the camera power supply exists, based on a result of the overcurrent detection by the overcurrent detection unit. Therefore, it is possible to normally detect whether the abnormality of the camera power supply exists.

According to a second aspect of the present disclosure, an electronic control unit supplies power to a camera via a communication line having a Power over Coax system. The electronic control unit includes a camera power supply, an overcurrent detection unit, a threshold modification unit, and an abnormality detection unit. The camera power supply generates the power that is supplied to the camera. The overcurrent detection unit executes overcurrent detection to detect an overcurrent of the camera power supply. The threshold modification unit modifies an overcurrent detection threshold value used for the overcurrent detection. The abnormality detection unit detects an abnormality of the camera power supply based on a result of the overcurrent detection, and the result is acquired in response to that the threshold modification unit modifies the overcurrent detection threshold value. Therefore, it is possible to normally detect whether the abnormality of the camera power supply exists.

The following describes several embodiments related to an electronic control unit. In the following embodiments, substantially same structural configurations are designated with the same reference symbols to simplify the description.

### First Embodiment

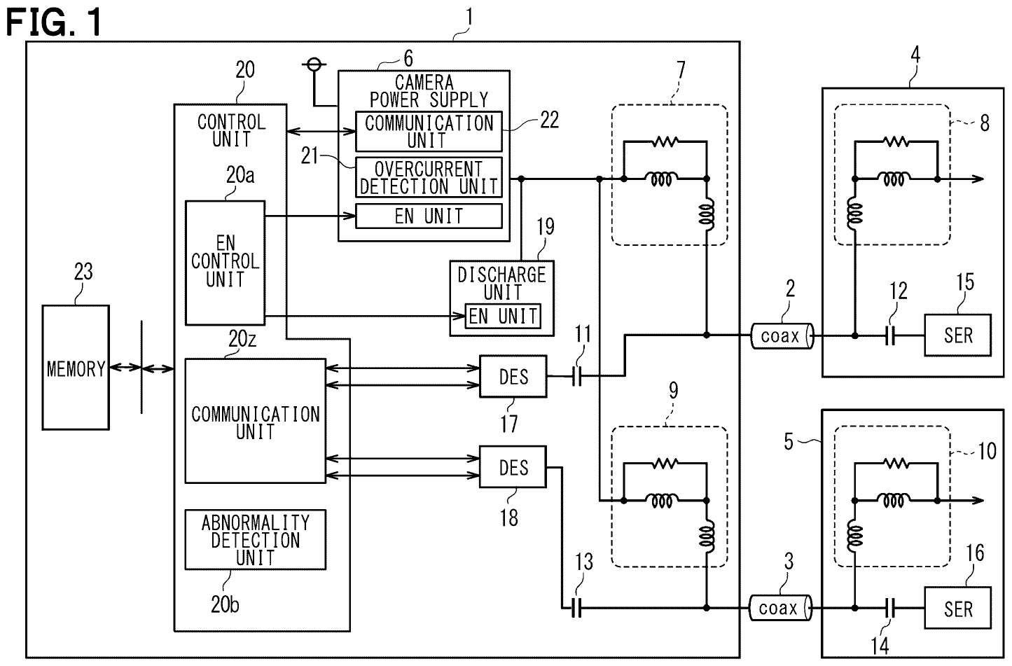

A first embodiment will be described with reference to FIGS. 1 to 4. As shown in FIG. 1, an electronic control unit 1 includes a control main unit that connects a memory 23 to a control unit 20, and additionally includes a camera power supply 6, PoC filters 7 and 9, deserializers 17 and 18, and a discharge unit 19. The electronic control unit 1 is connected to the camera 4 via the Coax cable 2. Additionally, the electronic control unit 1 is connected to the camera 5 via a Coax cable 3. The Coax cables 2 and 3 are used as communication lines between the electronic control unit 1 and the cameras 4 and 5, as well as power supply lines for supplying power from the camera power supply 6 to the cameras 4 and 5.

The control unit 20 includes a microcomputer and executes various controls by running a program stored in the memory 23. The control unit 20 of the present embodiment includes functions as an enable control unit 20a, an abnormality detection unit 20b, and a communication unit 20z. The control unit 20 may also be referred to as a controller. The communication unit 20z indicates a function that executes communication processing between the cameras 4 and 5, and with a communication unit 22 of the camera power supply 6, according to a predetermined communication standard. The camera power supply 6 is a power circuit for generating the power supply to be provided to the cameras 4 and 5. The camera power supply 6 includes a communication unit 22, enabling communication with the control unit 20. The camera power supply 6 can switch the power supply to cameras 4 and 5 on and off based on the enable control by the control unit 20. In the present disclosure, the enable control unit 20a may also be written as EN control unit as illustrated in, for example, FIG. 1.

Components of the PoC filters 7 and 9, which remove noise components from the power supply, are provided on the power line between the camera power supply 6 and the Coax cables 2 and 3. The PoC filters 7 and 9 include low-pass filters provided with resistors and inductors (without reference numerals) as illustrated. The PoC filters are not limited to the above configuration.

PoC filters 8 and 10 are also provided in the cameras 4 and 5, respectively. In addition to the PoC filter 8, the camera 4 includes a serializer 15, a coupling capacitor 12, and an image signal processing unit (not shown). In addition to the PoC filter 10, the camera 5 is equipped with a serializer 16, a coupling capacitor 14, and an image signal processing unit (not shown). The serializer 15 and the serializer 16 may also be written as SER as illustrated in, for example, FIG. 1.

The PoC filters 8 and 10 of the cameras 4 and 5 also include low-pass filters with resistors and inductors (without reference numerals) as illustrated. The PoC filters described here are also not limited to the above-mentioned configuration. The PoC filters 8 and 10 remove noise components from the power supplied through the Coax cables 2 and 3, respectively, and supply power to the interior of the cameras 4 and 5.

The cameras 4 and 5 are vehicle cameras that capture images of the vehicle's surroundings and interior conditions as video signals, respectively. When transmitting a video signal from the camera 4 to the control unit 20, the control unit 20 first performs initial settings between the serializer 15 and the deserializer 17 via I²C and establishes a link. Subsequently, the camera 4 transmits the video signal to the serializer 15. The serializer 15 outputs the video signal to the deserializer 17 via the coupling capacitor 12, the Coax cable 2, and the coupling capacitor 11. The deserializer 17 transmits the video signal to the control unit 20 via communication compliant with the MIPI standard.

When transmitting a video signal from the camera 5 to the control unit 20, the control unit 20 first performs initial settings between the serializer 16 and deserializer 18 via I²C and establishes a link. Subsequently, the camera 5 transmits the video signal to the serializer 16. The serializer 16 outputs the video signal to the deserializer 18 via the coupling capacitor 14, the Coax cable 3, and the coupling capacitor 13. The deserializer 18 transmits the video signal to the control unit 20 via communication compliant with the MIPI standard. As a result, the control unit 20 receives the video signals from the cameras 4 and 5 and sequentially stores them into the memory 23. Here, an example of a method for transmitting video signals using the I²C and MIPI communication standards has been described, but it is not limited to this, and video signals may be transmitted using other communication standards. The deserializer 17 and the deserializer 18 may also be written as DES as illustrated in, for example, FIG. 1.

The electronic control unit 1 includes a discharge unit 19 as a peripheral circuit of the camera power supply 6. The discharge unit 19 is connected to the output node of the camera power supply 6 and to the node on the upstream side of the PoC filters 7 and 9. The discharge unit 19 is a circuit block that enables the generated power of the camera power supply 6 to be discharged, and the operation of the discharge unit 19 can be switched between an enabled state and a disabled state by the control of the enable control unit 20a of the control unit 20.

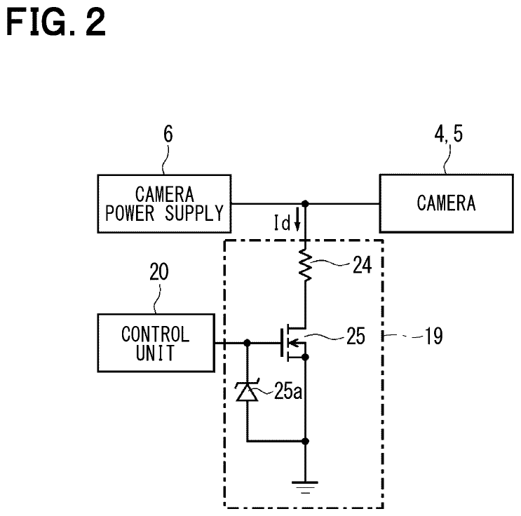

As shown in FIG. 2, the discharge unit 19 includes a resistor 24 through which a discharge current Id is conducted from the camera power supply 6, and a switch unit 25 that enables/disables the operation of the discharge unit 19. The switch unit 25 includes an N-channel type MOS transistor, with a Zener diode 25a added for gate protection of the MOS transistor. The control unit 20 can control the switch unit 25 by regulating the gate voltage of the MOS transistor. When the control unit 20 turns on the switch unit 25, the discharge current Id is conducted to ground through the resistor 24, allowing the discharge current Id to flow. The resistance value of resistor 24 is set to a level that is not for detecting overcurrent during normal operation of the cameras 4 and 5, but for detecting the overcurrent in the event of a power supply abnormality on the cameras 4 and 5 side.

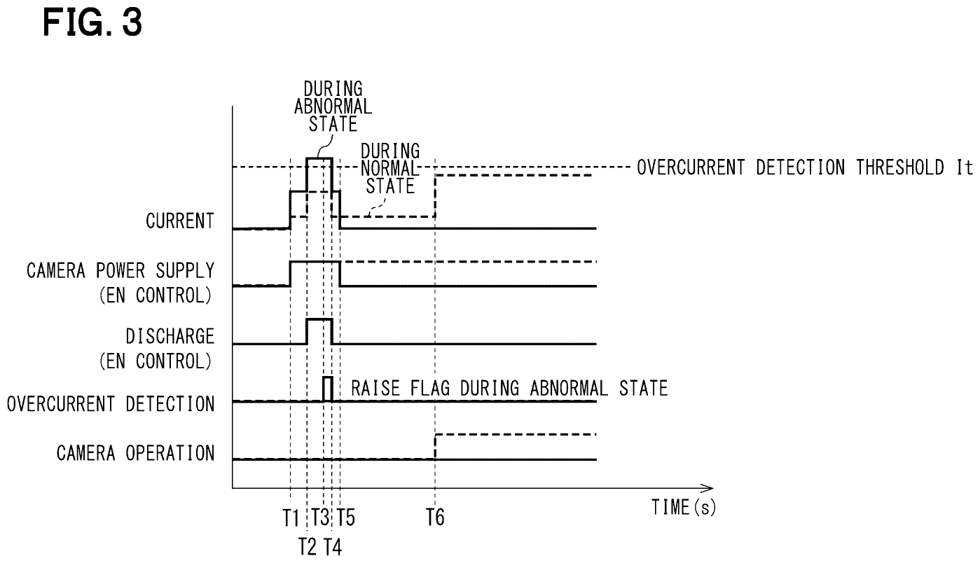

The following describes the overcurrent detection operation using the above configuration. At timing T1 in FIG. 3, the control unit 20 raises the enable control signal of the camera power supply 6. Then, the camera power supply 6 is started up. When the camera power supply 6 is started up, the operating current of the camera power supply 6 flows.

At this time, consider the case where the camera power supply 6 has a short-circuit fault internally. In the case of an abnormality in the camera power supply 6, the operating current will be larger (see T2 to T4 in FIG. 3) compared to when there is no abnormality. In the case of an abnormality, the control unit 20 raises the enable control signal of the discharge unit 19 at timing T2, and by activating the discharge unit 19, adds the discharge current Id to the operating current. The overcurrent detection unit 21 detects whether the output current of the camera power supply 6 has reached the overcurrent detection threshold It by monitoring the output current.

In the case of an abnormality in the camera power supply 6, the output current of the camera power supply 6 exceeds the overcurrent detection threshold It. Therefore, the overcurrent detection unit 21 detects an overcurrent abnormality at timing T3. When the overcurrent detection unit 21 detects the presence of an overcurrent abnormality, it sets a flag (see T3 in FIG. 3). The camera power supply 6 is equipped with an internal register, and if there is an abnormality in the camera power supply 6, it is stored into the internal register as an abnormality flag. After the overcurrent detection unit 21 detects the presence of an overcurrent abnormality and this information is provided to the control unit 20, the control unit 20 stops the enable control and halts the discharge current Id at timing T4. If the abnormality continues thereafter, the control unit 20 outputs an enable control signal to stop the camera power supply 6 at timing T5. Then, the camera power supply 6 stops its output. Since power is no longer supplied to the cameras 4 and 5 from the camera power supply 6, the cameras 4 and 5 will not be started up either.

On the other hand, under a normal state, even when the control unit 20 starts up and operates the discharge unit 19 to discharge after turning on the camera power supply 6 at timing T1, the output current of the camera power supply 6 does not exceed the overcurrent detection threshold It (refer to the dashed part of the current). In this case, the control unit 20 sets the discharge current Id to zero by disabling the operation of the discharge unit 19 after the completion of the overcurrent detection process by the overcurrent detection unit 21 (at timing T4). Then, the camera power supply 6 continues to supply power to the cameras 4 and 5 through the PoC filters 7 and 9, and the coax cables 2 and 3 (refer to the dashed part after timing T5).

The control unit 20 then instructs the cameras 4 and 5 to start up if no abnormality is detected. Upon receiving the startup instruction, the cameras 4 and 5 perform initialization, and at timing T6, the cameras 4 and 5 begin normal operation. This allows the presence or absence of an abnormality in the camera power supply 6 to be determined. In the present disclosure, the wording “startup” may also be referred to as “activation”.

### Comparative Example

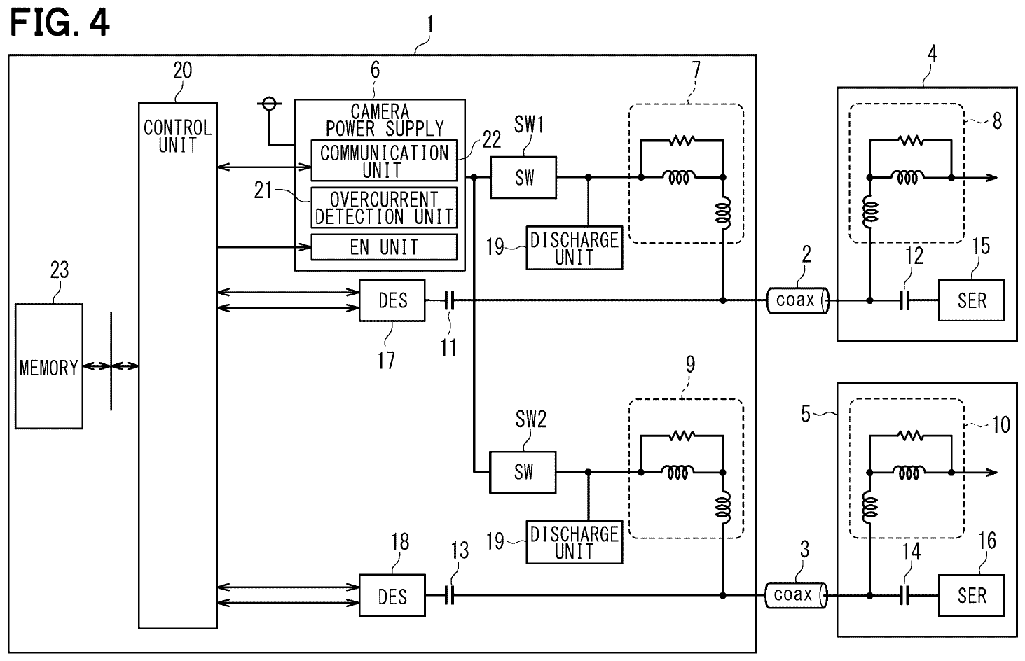

FIG. 4 shows a comparative example. In this FIG. 4, switch circuits SW1 and SW2 are provided in the power supply paths from the camera power supply 6 to each of the cameras 4 and 5. The switch circuits SW1 and SW2 are provided for each of the cameras 4 and 5 individually. In the event of a power supply abnormality in the camera power supply 6, the switch circuits SW1 and SW2 can be turned off individually to stop the power supply to the cameras 4 and 5 separately. This allows the imaging operations of the cameras 4 and 5 that are capable of normal operation to continue. However, as the number of connected cameras 4 and 5 increases, the number of switch circuits SW1 and SW2 also increases, and it becomes necessary to provide the discharge unit 19 for the internal charge of each camera 4 and 5. This leads to increased costs and larger sizes, which is undesirable.

### Summary of First Embodiment

According to this embodiment, the overcurrent detection unit 21 detects the presence of overcurrent in the camera power supply 6 while the discharge unit 19 is effectively operated by the control unit 20 during the startup of the camera power supply 6. Based on the overcurrent detection result of the overcurrent detection unit 21, it detects an abnormality in the camera power supply 6. This allows the detection of power supply abnormality without the need for using switch circuits SW1 and SW2. Since the determination of whether there is a power supply abnormality is made based on the output current of the camera power supply 6, it is possible to accurately identify whether a power supply abnormality is present.

The control unit 20 enables the discharge unit 19 to operate effectively after the camera power supply 6 is started. After the overcurrent detection process by the overcurrent detection unit 21 is completed, the control unit 20 disables the operation of the discharge unit 19. If no abnormality is detected, the control unit 20 then instructs the cameras 4 and 5 to start up. Since an abnormality can be detected immediately after the startup of the camera power supply 6, the output of the camera power supply 6 can be stopped immediately. As a result, the power supply abnormality is not allowed to persist, thereby protecting the components.

The resistance value of the resistor 24 is set to a level that is not for detecting the overcurrent during the normal operation of the cameras 4 and 5, but is for detecting the overcurrent only during an abnormal state of the camera power supply 6. This allows the overcurrent detection threshold It to be set at an appropriate level. As a result, the overcurrent can be detected only during the power abnormality, preventing false detection of the power abnormality during the normal operation.

### Second Embodiment

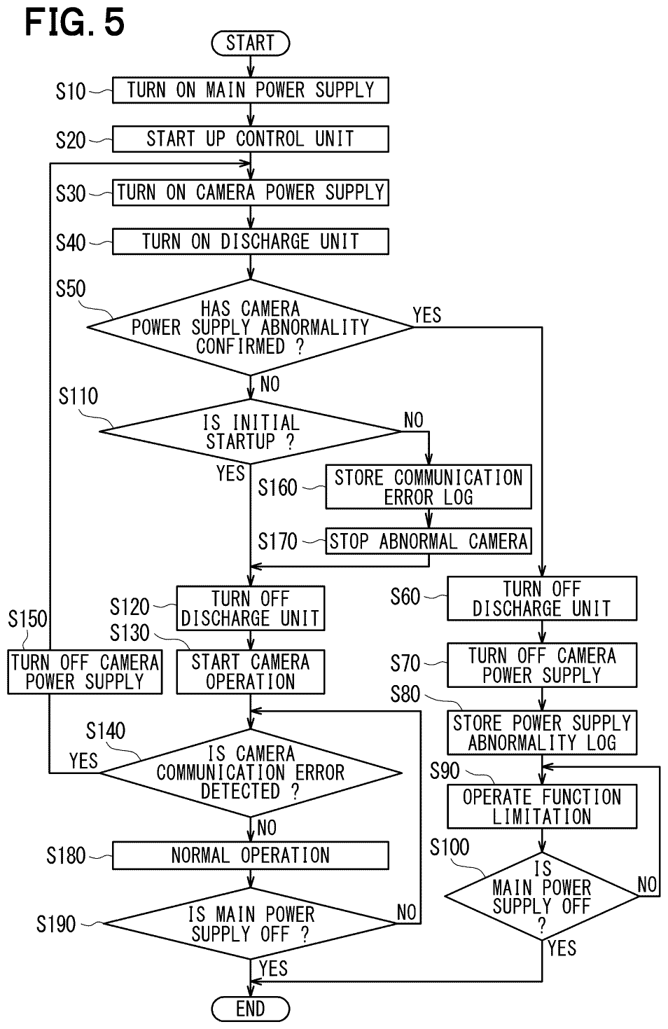

The following describes a second embodiment with reference to FIG. 5. In this embodiment, a detailed explanation of a processing example using the configuration of the first embodiment will be provided. The operation after the ignition switch inside the vehicle is turned on by the occupant will be explained. When the ignition switch is turned on by the occupant to start the engine, the main power supply of the electronic control unit 1 is turned on at S10 in FIG. 5. As a result, power supply to each circuit of the electronic control unit 1 begins, and the control unit 20 starts up in S20.

The control unit 20, in S30, starts up the camera power supply 6 through enable control (timing T1 in FIG. 3). The control unit 20 also starts up the discharge unit 19 by enable control in S40 (timing T2 in FIG. 3). The overcurrent detection unit 21 then determines whether or not the camera power supply 6 is abnormal by detecting whether or not the output current of the camera power supply 6 exceeds the overcurrent detection threshold It in S50. The camera power supply 6 is equipped with internal registers, and if there is an abnormality in the camera power supply 6, it is recorded as an abnormal flag in the internal registers (timing T3 in FIG. 3).

If there is an abnormality in the camera power supply 6, the control unit 20 determines that the abnormality in the camera power supply 6 is confirmed and, in S60, disables the operation of the discharge unit 19 and stops the discharge unit 19 (timing T4 in FIG. 3). The control unit 20, in S70, stops the camera power supply 6 through enable control (timing T5 in FIG. 3). The control unit 20, in S80, stores the power supply abnormality log into the memory 23.

If there is an abnormality in the camera power supply 6, the electronic control unit 1 enters a function restriction mode in S90, where only minimal communication processing, such as CAN communication, can be performed. Subsequently, in S100, if the main power is on, the electronic control unit 1 continues the function restriction mode, and when the ignition switch is operated and the main power is turned off, all operations are stopped.

On the other hand, if the control unit 20 determines that there is no abnormality in the camera power supply 6, the control unit makes a negative determination (NO) in S50, and then performs an initial startup determination in S110. In the case of an initial startup, the control unit 20 proceeds to S120, disables the operation of the discharge unit 19, and stops the discharge unit 19 (timing T4 in FIG. 3). The control unit 20 performs initialization settings for the cameras 4 and 5 in S130. Once the operation of the cameras 4 and 5 begins, operating current starts to flow to the cameras 4 and 5 (timing T6 in FIG. 3).

When the operation of the cameras 4 and 5 starts in S130, the control unit 20 proceeds to S140, where it uses the functionality of the abnormality detection unit 20b to detect any communication error related to the cameras 4 and 5, such as I²C, MIPI, or LVDS communication issues. For example, in I²C communication, the system detects communication error such as the presence of NACK detection, timeouts, or verification errors. When executing communication processing, the communication unit 20z attaches an error detection code to the communication. After the completion of the communication, it prohibits the write operation of the communication data. Therefore, functional safety can be achieved.

If a communication error with the cameras 4 and 5 is detected, the control unit 20 turns off the camera power supply 6 in S150 and then returns the process to S30 to turn the camera power supply 6 back on, thereby restarting the camera power supply 6. In the subsequent processes starting from S50, the overcurrent detection unit 21 again detects whether an overcurrent is occurring in the output current of the camera power supply 6, thereby performing the detection of any abnormalities in the camera power supply 6. Through this series of processes, it is possible to distinguish whether the issue is a communication error with cameras 4 and 5 or an abnormality in the camera power supply 6.

If there is a power supply abnormality in the camera power supply 6, an affirmative determination (YES) is made in S50, and the process proceeds to S60 to S100. Conversely, if the power supply abnormality of the camera power supply 6 is not detected, the control unit 20 will make a negative determination (NO) at S50 and will again perform the initial startup determination at S110. Since this is the second startup and not the initial startup, it will be concluded at S160 that there is a communication error. The control unit 20 stores the communication error log into the memory 23 at S160. The control unit 20 stops only the camera that was determined to be abnormal at S170 (for example, the camera 4 in this case) and then returns to the processing flow from S120 onwards. At this time, it can be confirmed that the communication error is with the camera 4 and not an issue with the camera power supply 6. The control unit 20 initiates communication with another camera 5 at S130. If no communication error is detected, the control unit 20 makes a negative determination (NO) at S140 and executes normal operation at S180.

If a communication error is detected with another camera 5 at S140 during the second startup, the control unit 20 stops the operation of the camera power supply 6 again at S150, returns to the process at S30, and repeats the process. At this time, if there is a communication error with another camera 5, the control unit 20 stores the communication error log into the memory 23 at S160 and also stops the other camera 5 at S170. As a result, it is possible to determine whether there is an abnormality in the camera power supply 6 or an abnormality in any of the cameras (for example, the cameras 4 or 5).

On the other hand, if no camera communication error is detected at S140 during the initial startup and subsequent startup, communication with the cameras 4 and 5 is determined to be normal, and normal operation begins at S180. At S190, until the main power is turned off, the control unit 20 continuously monitors for communication error with the cameras 4 and 5. The control unit 20 stops all operations when the main power is turned off at S190.

### Summary of Second Embodiment

According to the present embodiment, the same operational effects as those of the aforementioned first embodiment can be achieved. Additionally, if the control unit 20 determines a communication error after the operation of the cameras 4 and 5 has started, it restarts the camera power supply 6 and then detects the presence or absence of an overcurrent using the overcurrent detection unit 21 again. With this configuration, it is possible to distinguish and determine whether the issue is a power supply abnormality or a communication error in the camera power supply 6. Since the camera power supply 6 can be shut down without continuing the abnormal state of the camera power supply 6, it is possible to protect the components provided downstream of the camera power supply 6 (for example, the PoC filters 7 to 10).

### Third Embodiment

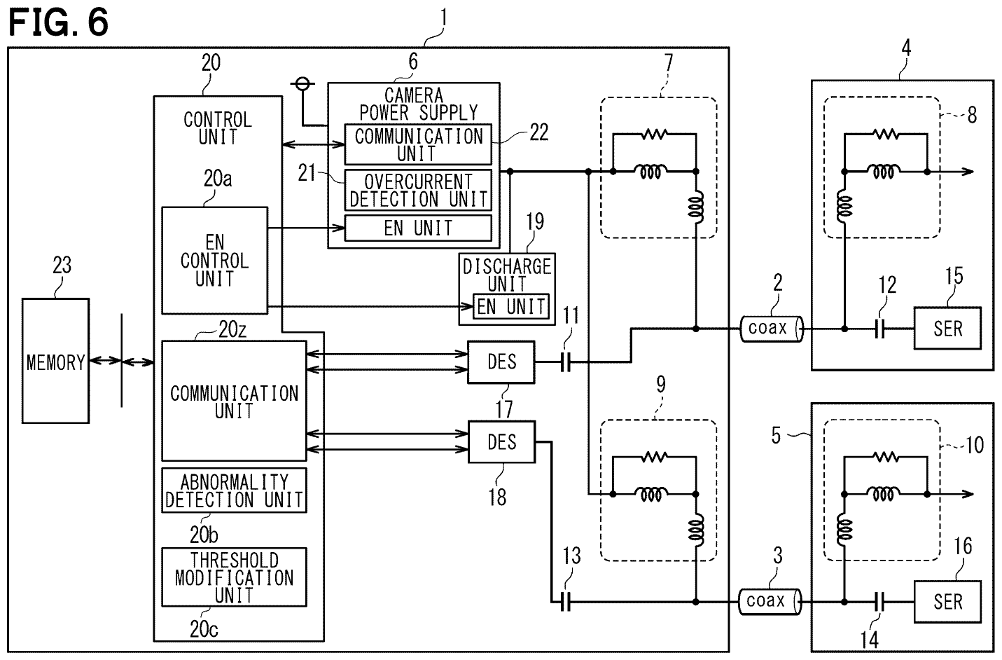

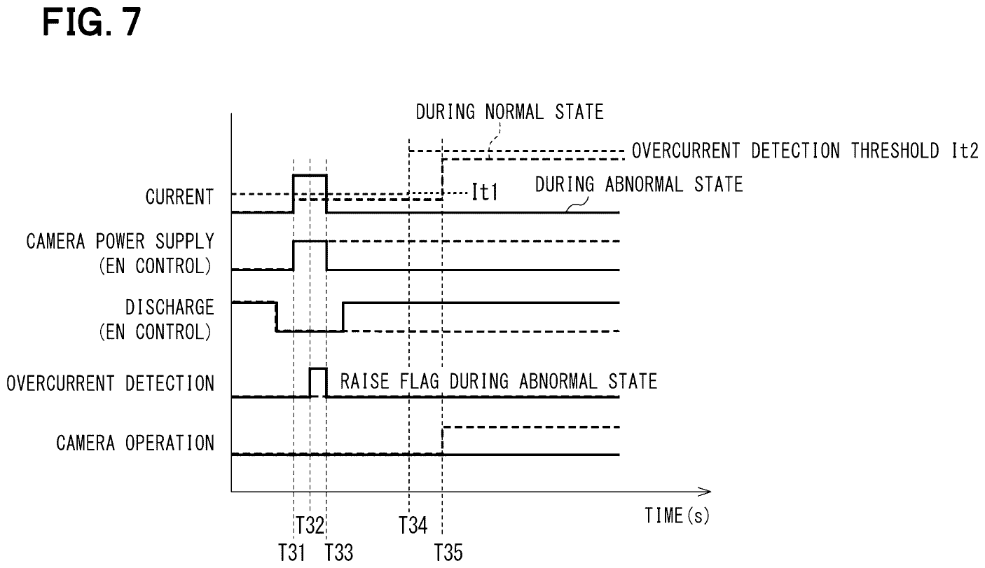

The following describes a third embodiment with reference to FIGS. 6 and 7. In the third embodiment, the mode in which the overcurrent detection thresholds It1 and It2 for detecting an overcurrent are modified will be explained. In this embodiment, as shown in FIG. 6, the control unit 20 has a function as a threshold modification unit 20c. The other configurations are the same as those in the first and second embodiments, and therefore, their descriptions are omitted.

As shown in FIG. 7, the control unit 20 firstly discharges the load capacitor via the discharge unit 19 before the timing T31. Then, the control unit 20 stops the operation of the discharge unit 19 through enable control. Additionally, the control unit 20 sets the overcurrent detection threshold It1 of the overcurrent detection unit 21 as the initial value. The overcurrent detection threshold It1 is set in advance to be smaller than the overcurrent detection threshold It2, which will be described later, and larger than the current consumption when supplying power to the cameras 4 and 5. The overcurrent detection threshold It1 corresponds to a predetermined threshold value before modification.

The overcurrent detection threshold It1 is set such that it is not detected as an overcurrent by the overcurrent detection unit 21 during normal operation of the cameras 4 and 5, even when powered by the camera power supply 6, but is detected as an overcurrent only in the event of an abnormality in the cameras 4 and 5. Additionally, the overcurrent detection thresholds It1 and It2 are set below the rated values of the components of the PoC filters 7 and 9.

At timing T31, the control unit 20 raises the enable control signal of the camera power supply 6 and starts up the camera power supply 6. At this time, if the camera 4 or 5 experiences an internal fault (for example, a short circuit in camera 4) and an abnormality occurs in the camera power supply 6, the operating current will be larger compared to when there is no abnormality. If an abnormality occurs in the camera power supply 6, the current will exceed the preset overcurrent detection threshold It1. Therefore, the overcurrent detection unit 21 can detect an overcurrent at timing T32 and raise an abnormality detection flag (see the solid line portion of the current). If the overcurrent detection unit 21 detects an abnormality and determines that there is an abnormality, the control unit 20 will stop the camera power supply 6 at timing T33. After that, the control unit 20 operates the discharge unit 19 through enable control, short-circuiting the output of the camera power supply 6 to ground.

Conversely, if the system is operating normally, the output current of the camera power supply 6 does not exceed the preset overcurrent detection threshold It1, and the overcurrent detection unit 21 does not detect any abnormality (see the dashed line portion of the current). In this case, the control unit 20 initializes the system to operate cameras 4 and 5. However, at timing T34, before the operation of the cameras 4 and 5 begins, the overcurrent detection threshold It1 of the overcurrent detection unit 21 is modified to the overcurrent detection threshold It2 (where It2>It1).

The overcurrent detection threshold It2 is set to a value that is higher than the output current of the camera power supply 6 when all cameras 4 and 5 are operating. After that, at timing T35, the cameras 4 and 5 start normal operation, and normal operating current flows to the cameras 4 and 5. Even if the operating current of the cameras 4 and 5 increases and the output current of the camera power supply 6 increases, it does not reach the overcurrent detection threshold It2. Therefore, the overcurrent detection unit 21 does not detect an overcurrent (see the normal operation after timing T35 indicated by the dashed line in FIG. 7).

### Summary of Third Embodiment

According to this embodiment, the control unit 20 modifies the overcurrent detection thresholds It1 and It2 for the overcurrent detection unit 21 to detect overcurrent. By changing the overcurrent detection thresholds It1 and It2 via the threshold modification unit 20c, the presence or absence of abnormalities in the camera power supply 6 is detected based on the overcurrent detection results of the overcurrent detection unit 21. As a result, power supply abnormality can be detected normally without using switch circuits SW1 and SW2. Since the determination is made based on the output current of the camera power supply 6, it is possible to determine whether there is a power supply abnormality or not.

The control unit 20 modifies the overcurrent detection threshold from the previous threshold It1 to a higher threshold It2 according to the operating state of the cameras 4 and 5. Based on the overcurrent detection results from the overcurrent detection unit 21, it detects abnormalities in the camera power supply 6. Since the overcurrent detection thresholds It1 and It2 can be modified according to the operating state of the cameras 4 and 5, it can be set so that overcurrent is not detected during normal operation after the cameras 4 and 5 have started operating.

The overcurrent detection threshold It1 is set so that it is not detected as overcurrent by the overcurrent detection unit 21 even when power is supplied from the camera power supply 6 during the normal operation of the cameras 4 and 5, but is detected as overcurrent only during an abnormal state of the cameras 4 and 5. This prevents false detection of power supply abnormality during normal operation. The overcurrent detection thresholds It1 and It2 are set below the ratings of the components of the PoC filters 7 and 9 on the power supply line, thereby preventing failure of the components of the PoC filters 7 and 9.

### Fourth Embodiment

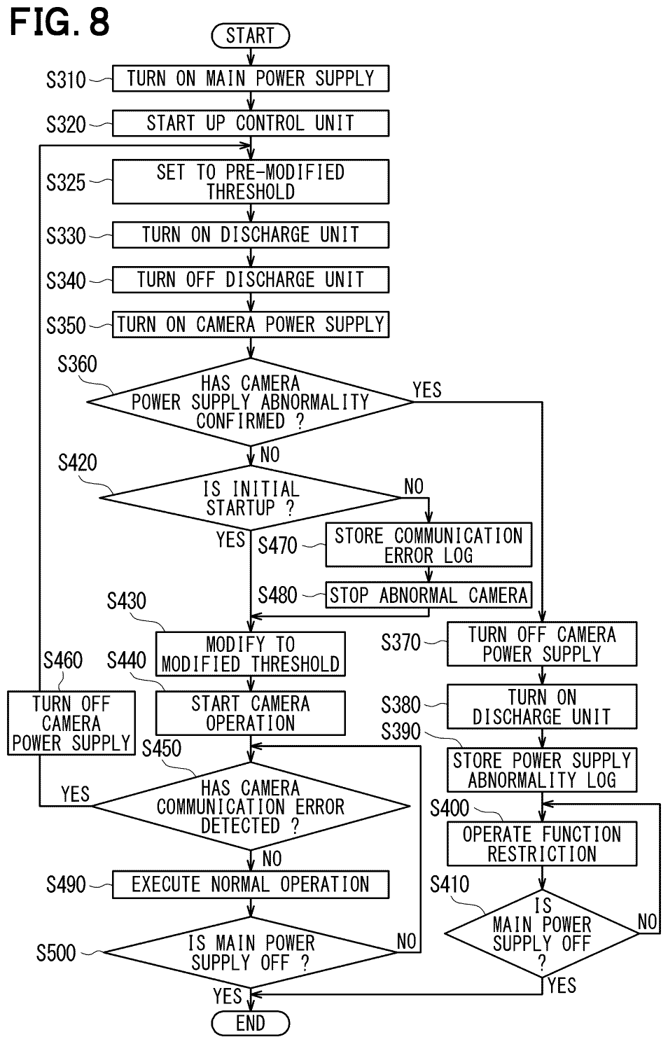

The following describes a fourth embodiment with reference to FIG. 8. In this embodiment, a processing example using the configuration of the third embodiment will be described in detail. The operation after the ignition switch inside the vehicle is turned on by the occupant will be explained. The operation after the ignition switch in the vehicle is turned on by the occupant will be explained. Then, power supply to each circuit of the electronic control unit 1 is started, and the control unit 20 is started up in S320. In S325, the control unit 20 enables the overcurrent detection unit 21 and sets the threshold of the overcurrent detection unit 21 to the overcurrent detection threshold It1 (a pre-modified threshold).

The control unit 20, in S330, starts up the discharge unit 19 through enable control to perform discharge, and then, in S340, stops the operation of the discharge unit 19 through enable control. In S350, the control unit 20 starts up the camera power supply 6 through enable control (timing T31 in FIG. 7).

The camera power supply 6 may be constructed such that its output voltage can be adjusted by the control unit 20. Initially, when the camera power supply 6 is started up, it may output a large first predetermined voltage as a default value that does not reach the maximum rated power supply voltage of the cameras 4 and 5. As a result, the abnormal current during the abnormal state of the camera increases, and the difference in current between the normal operation and the abnormal state becomes larger, thereby improving the accuracy of overcurrent detection.

Then, in S360, the overcurrent detection unit 21 detects whether the current flowing to the camera power supply 6 exceeds the overcurrent detection threshold value It1, and determines whether there is an abnormality in the camera power supply 6. The camera power supply 6 is equipped with an internal register, and if there is an abnormality in the camera power supply 6, it is stored into the internal register as an abnormality flag.

If there is an abnormality in the camera power supply 6, the control unit 20 determines that the abnormality in the camera power supply 6 is confirmed, and in S370, the control unit 20 stops the camera power supply 6 through enable control (timing T33 in FIG. 7). The control unit 20 discharges by activating the discharge unit 19 in S380. In S390, the power supply abnormality log is stored into the memory 23. In S400, the electronic control unit 1 enters a function restriction mode, allowing only the minimum necessary communication processing, such as CAN communication. After that, in S410, if the main power supply is turned on, the electronic control unit 1 continues the function restriction mode, and when the ignition switch is operated and the main power supply is turned off, all operations are stopped.

On the other hand, if the control unit 20 determines that there is no abnormality in the camera power supply 6, a negative determination (NO) is made in S360 and performs the initial startup determination in S420. In the case of the initial startup, the control unit 20 proceeds to S430 and modifies the detection threshold of the overcurrent detection unit 21 to the overcurrent detection threshold It2 (modified threshold) (timing T34 in FIG. 7). The control unit 20 performs initialization settings to start the operation of the cameras 4 and 5 in S440. When the cameras 4 and 5 start operating, operating current begins to flow to the cameras 4 and 5 (timing T35 in FIG. 7).

At this time, it is possible for the control unit 20 to stabilize the operating voltage by lowering the output voltage of the camera power supply 6 from the initial startup. In S350, a large first predetermined voltage that does not reach the maximum rated power supply voltage of the cameras 4 and 5 was applied in advance as a default value to inspect the output current abnormality of the camera power supply 6. However, when normally operating the cameras 4 and 5, it is possible to set the output voltage of the camera power supply 6 to a second predetermined voltage that is smaller than the first predetermined voltage. The operating current can be made relatively small during normal operation. Since the overcurrent becomes excessively large during the startup inspection, the difference between the abnormal state and the normal operation can be made significant, allowing for stable detection of overcurrent during startup.

When the cameras 4 and 5 start operating in S440, the control unit 20 in S450 detects abnormality in the communications with the cameras 4 and 5, such as I²C, MIPI, and LVDS, using the function of the abnormality detection unit 20b. For example, in I²C communication, the system detects communication error such as the presence of NACK detection, timeouts, or verification errors. When executing communication processing, the communication unit 20z attaches an error detection code to the communication. After the completion of the communication, it prohibits the write operation of the communication data. Therefore, functional safety can be achieved.

If a communication error with the cameras 4 and 5 is detected, the control unit 20 turns off the camera power supply 6 in S460, and returns to S325 to reset the detection threshold of the overcurrent detection unit 21 to the overcurrent detection threshold It1. Then, the control unit 20 starts up the discharge unit 19 in S330 to discharge, and stops the operation of the discharge unit 19 in S340. The control unit 20 restarts the camera power supply 6 by turning it on again in S350. In the subsequent S360, the overcurrent detection unit 21 again detects whether an overcurrent is occurring in the output current of the camera power supply 6, thereby executing the detection of any abnormality in the camera power supply 6. This allows distinguishing between a communication error with the cameras 4 and 5 and an abnormality in the camera power supply 6.

If there is an abnormality in the camera power supply 6, an affirmative determination (YES) is made in S360, and the process proceeds to S370 to S410. Conversely, if there is no abnormality in the camera power supply 6, the control unit 20 makes a negative determination (NO) in S360 and performs the initial startup determination again in S420. Since this is the second startup and not the initial startup, the process proceeds to S470 and determines that there is a communication error. In S470, the control unit 20 stores the communication error log into the memory 23. In S480, the control unit 20 stops only the camera that was determined to be abnormal (for example, the camera 4 in this case) and then returns to the processing flow from S430 onward. At this time, it can be confirmed that the communication error is with the camera 4 and not an issue with the camera power supply 6. In S440, the control unit 20 initiates communication with the other camera 5, and if no communication error is detected, the control unit 20 makes a negative determination (NO) in S450 and performs normal operation in S490.

If a communication error is detected with the other camera 5 in S450 during the second startup, the control unit 20 stops the operation of the camera power supply 6 again in S460 and repeats the process from S325. At this time, if there is a communication error with the other camera 5, the control unit 20 stores the communication error log into the memory 23 in S470 and also stops the other camera 5 in S480. As a result, it is possible to determine whether there is an abnormality in the camera power supply 6 or an abnormality in any of the cameras (for example, cameras 4 or 5).

On the other hand, if no camera communication error is detected in S450 at the first or second startup, communication with the cameras 4 and 5 is determined normal and the normal operation is started in S490. Until the main power is turned off in S500, the control unit 20 constantly detects communication error with the cameras 4 and 5. The control unit 20 stops all operations when the main power is turned off in S500.

### Summary of Fourth Embodiment

According to this embodiment, the same effects as those described in the third embodiment mentioned above are achieved. Also, since the control unit 20 modifies the overcurrent detection threshold from It1 to It2 in S430 before the operation start of the cameras 4 and 5, it can detect whether an overcurrent has occurred using the correct overcurrent detection threshold It2 during the operation of the cameras 4 and 5.

Additionally, if a communication error is determined after the operation start of the cameras 4 and 5 in S440, the camera power supply 6 restarts through S460, S325, S330, and S340, and the overcurrent detection unit 21 detects overcurrent again in S360. If the overcurrent detection unit 21 detects an overcurrent, it is determined to be a power supply abnormality of the camera power supply 6. If no overcurrent is detected, it can be concluded that there is a communication error. This allows for the differentiation between a power supply abnormality and a communication error, protecting the components without continuing the power abnormality.

During the restart of the camera power supply 6 (S460→S350), the overcurrent detection unit 21 modifies the detection threshold back from the modified overcurrent detection threshold It2 (modified threshold) to the original overcurrent detection threshold It1, so that it detects overcurrent accordingly. This allows for the detection of power supply abnormality immediately after the restart of the camera power supply 6.

### OTHER EMBODIMENTS

The present disclosure is not limited to the embodiment described above, and, for example, may be modified or expanded, which will be described. The communication line is not limited to the Coax cables 2 and 3. While the electronic control unit 1 has been described with a system connecting multiple cameras 4 and 5, it is not limited to this. It can also be applied to a system connecting a single camera (e.g., the camera 4) or to a system connecting three or more cameras 4, 5, and others.

The control unit and method described in the present disclosure may be implemented by a special purpose computer which is configured with a memory and a processor programmed to execute one or more particular functions embodied in computer programs of the memory. Alternatively, the control unit described in the present disclosure and the method thereof may be realized by a dedicated computer configured as a processor with one or more dedicated hardware logic circuits. Alternatively, the control unit and method described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible recording medium as an instruction executed by the computer.

Although the present disclosure has been described in accordance with the embodiments, it is understood that the present disclosure is not limited such embodiments or structures described in the embodiments. The present disclosure includes various modification examples and modifications within the equivalent scope. In addition, various combinations and modes, and other combinations and modes including only one element, more elements, or less elements are also within the scope and idea of the present disclosure.

What is claimed is:

1. An electronic control unit configured to use a Power over Coax system to supply power to a camera via a communication line, the electronic control unit comprising:
a camera power supply configured to generate the power that is supplied to the camera;
a discharge unit configured to discharge the power that is generated by the camera power supply;
an enable control unit configured to switch an operation of the camera power supply and an operation of the discharge unit between an enabled state and a disabled state;
an overcurrent detection unit configured to execute overcurrent detection to detect whether an overcurrent exists in the camera power supply, on a condition that the enable control unit switches the operation of the discharge unit to the enabled state at startup of the camera power supply; and
an abnormality detection unit configured to detect whether an abnormality of the camera power supply exists, based on a result of the overcurrent detection.

2. The electronic control unit according to claim 1, wherein
the enable control unit is configured to:
switch the operation of the discharge unit to the enabled state after the startup of the camera power supply;
switch the operation of the discharge unit to the disabled state after completion of a process of the overcurrent detection executed by the overcurrent detection unit; and
provide a startup instruction to the camera on a condition that the abnormality detection unit does not detect the abnormality.

3. The electronic control unit according to claim 1, wherein
the discharge unit includes a resistor configured to conduct a current from the camera power supply, and
a resistance value of the resistor is set to a level for the overcurrent detection unit to detect the overcurrent only during an abnormal state of the camera power supply, and the level is set for the overcurrent detection unit not to detect the overcurrent during a normal operation of the camera.

4. The electronic control unit according to claim 1, wherein
the overcurrent detection unit is configured to
restart the camera power supply based on determining that a communication error has occurred after initiation of an operation of the camera, and then
detect again whether the overcurrent exists in response to the restart.

5. An electronic control unit configured to use a Power over Coax system to supply power to a camera via a communication line, the electronic control unit comprising:
a camera power supply configured to generate the power that is supplied to the camera;
an overcurrent detection unit configured to execute overcurrent detection to detect whether an overcurrent exists in the camera power supply;
a threshold modification unit configured to modify an overcurrent detection threshold value used in the overcurrent detection; and
an abnormality detection unit configured to
acquire a result of the overcurrent detection in response to modification of the overcurrent detection threshold value by the threshold modification unit, and
detect whether an abnormality of the camera power supply exists based on the result of the overcurrent detection.

6. The electronic control unit according to claim 5, wherein
the threshold modification unit is configured to modify the overcurrent detection threshold value from a pre-modified threshold value to a modified threshold value according to an operation state of the camera, the pre-modified threshold value being a predetermined value, the modified threshold value larger than the pre-modified threshold value.

7. The electronic control unit according to claim 6, wherein
a component is located on a power supply line between the camera power supply and the camera,
the pre-modified threshold value is set to a level for the overcurrent detection unit to detect the overcurrent only during an abnormal state of the camera, and the level is set for the overcurrent detection unit not to detect the overcurrent during a normal operation of the camera even though the camera is electrically conducted by the camera power supply, and
the pre-modified threshold value is equal to or lower than a rated value of the component.

8. The electronic control unit according to claim 5, wherein
the threshold modification unit is configured to modify the overcurrent detection threshold value before initiation of an operation of the camera.

9. The electronic control unit according to claim 5, wherein
the overcurrent detection unit is configured to
restart the camera power supply based on determining that a communication error has occurred after initiation of an operation of the camera, and then
detect again whether the overcurrent exists.

10. The electronic control unit according to claim 9, wherein
the overcurrent detection unit is configured to
modify the overcurrent detection threshold value from a modified threshold value back to a pre-modified threshold value, and then
execute the overcurrent detection at restart of the camera power supply.

11. The electronic control unit according to claim 1, further comprising:
a communication unit configured to:
execute communication provided with an error checking code via the communication line; and
prohibit a write operation of communication data after completion of the communication.

12. The electronic control unit according to claim 5, wherein
the camera power supply is configured to:
adjust an output voltage of the camera power supply to a first predetermined voltage in a case where the overcurrent detection unit detects whether the abnormality of the camera power supply exists in response to startup of the camera power supply, the first predetermined voltage lower than a maximum rated power supply voltage of the camera; and
adjust the output voltage of the camera power supply to a second predetermined voltage before causing the camera to execute a normal operation, the second predetermined voltage lower than the first predetermined voltage.

13. An electronic control unit configured to use a Power over Coax system to supply power to a camera via a communication line, the electronic control unit comprising:
a camera power supply configured to generate the power that is supplied to the camera; and
a processor and a memory that stores instructions configured to, when executed by the processor, cause the processor to:
discharge the power that is generated by the camera power supply;
switch an operation of the camera power supply and an operation of the discharge unit between an enabled state and a disabled state;
execute overcurrent detection to detect whether an overcurrent exists in the camera power supply, on a condition that the enable control unit switches the operation of the discharge unit to the enabled state at startup of the camera power supply; and
detect whether an abnormality of the camera power supply exists, based on a result of the overcurrent detection.
